(19) United States
(12) Patent Application Publication
(10) Pub. No.: US 2016/0335726 A1
(43) Pub. Date: Nov. 17, 2016

(54) QUOTE EXCHANGE SYSTEM AND METHOD FOR OFFERING COMPARATIVE RATES FOR AN INSURANCE PRODUCT

(71) Applicant: Endless River Technologies LLC, Medina, OH (US)

(72) Inventors: Richard Bonitz, Medina, OH (US); Phil Wintering, Aurora, OH (US)

(21) Appl. No.: 15/153,130

(22) Filed: May 12, 2016

Related U.S. Application Data
(60) Provisional application No. 62/160,418, filed on May 12, 2015.

(51) Int. Cl. G06Q 40/08; G06Q 40/02

(52) U.S. Cl. CPC G06Q 40/08; G06Q 40/02

(57) ABSTRACT

A method and system for furnishing comparison quotes for an insurance or financial services product, such as auto insurance, makes use of computer hardware, software and a network to provide a user with on-line real-time quotes from a plurality of insurance carriers. The system allows the user to input user information on an on-line application and be presented with an initial quote from a referring party. The user may select to compare the initial quote with one or more comparison quotes. The user information may be sent to a quote exchange application. Within the quote exchange application, an acquisition model of a plurality of partner insurance companies may be compared to third-party data associated with the user provided information. At least one rating engine analyzes the user entered information and other data to produce a comparison insurance rate. The user may be presented comparison quotes from various insurance companies.

### FIELD OF THE INVENTION

The present invention relates generally to the field of electronic commerce, and more particularly to a method and system for providing a user with comparative quotes for an insurance product or financial services product, such as an auto insurance product, from a plurality of insurance carriers.

### BACKGROUND

Presently available marketing methods for insurance products, such as auto insurance, includes a mix of traditional and more recent technical solutions such as search engines, lead aggregators, and quote system application websites for insurance companies. These on-line tools may be used to provide comparative information such as non-binding offers for rates from various insurance carriers to customers looking for an insurance policy.

In the current environment, consumers (users) may search for and purchase insurance policies on the internet from various sources. The user may be directed to the web-site of a lead aggregator or directly to the insurance company's web page. Lead aggregation systems are a tool used to gather a large number of leads to streamline the sales process where leads are followed up on or sold to others. If at a lead aggregator, the user may be prompted to input “user provided information” such as vehicle type, coverage limits, name, address, age, and other data. This user provided information may be sold as a customer lead to insurance companies that may be interested in providing an insurance quote to the user. Lead aggregators generally do not provide quotes directly to the user. The insurance company that purchased the customer lead would consider the user provided information as well as purchased third party information before a quote may be provided to the user. There is no guarantee that the potential customer will purchase a policy from the insurance company.

If the user is at a website of an insurance company, the user may be prompted to input the user provided information wherein the insurance company further purchases and analyzes various types of “third-party data.” This third-party data includes consumer credit data which is utilized in scoring the potential customer to the insurance company's proprietary ‘scoring models’ (algorithms that help identify an insurance company's preferred customer). These scoring models help the insurance company determine an insurance premium to be offered, and the underwriting acceptability/desirability of the user. Generally, insurance scoring models are proprietary to the insurance company offering the quote and are not shared with other insurance companies, lead aggregators, or other marketing entities. Many insurance companies have their own insurance scoring model, while some simply utilize generic scoring models provided by and owned by a credit agency.

It has been found that many potential auto insurance customers prefer to shop for comparative rates before purchasing an insurance policy. Therefore, lead aggregators and some insurance companies have displayed estimated comparison rates for policies from a plurality of other insurance companies to allow the user to compare rates that may be available to them from other insurance companies.

However, in the current environment, the comparison rates provided by the lead aggregator or initial quoting insurance company may not be accurate relative to the actual proprietary insurance scoring models and user provided information that are relied on to provide binding insurance quotes by the comparison insurance companies. This inaccuracy may be the result of user provided data and the lack of access to each insurance carrier's scoring models, as insurance scoring models remain generally proprietary, confidential, and are not shared. This may cause inconsistencies between the comparison rates provided by the initial insurance company and the actual quote provided by the compared insurance company that may be selected by the user.

Further, the comparison rates provided by the lead aggregator or initial quoting insurance company may not constitute a binding offer for an insurance policy as the rates may not be accurate or even recognized by the selected compared insurance company. Additionally, in the case of the initial quoting carrier process, the provided comparison rates do not allow the user to directly access the compared insurance company's rate offering. The user may also be prompted to start a new application for an insurance policy with the selected insurance company. The user is typically prompted to start a new application for an insurance policy with the selected insurance company. As such, the user may not have the option of purchasing an insurance policy at the comparison rate quoted by the lead aggregator or initial insurance company.

This causes insurance companies to suffer inefficiencies and increased marketing costs. In particular, money paid by insurance companies to lead aggregators for leads on potential customers may not actually amount to the user purchasing the insurance policy from either the initial or the compared insurance companies. Some lead aggregators may allow the quoting insurance company to be at least partially reimbursed for purchasing a lead by allowing other insurance companies to be directly accessible from the quoting insurance company's rate page through a click to the other carrier's web site. However, even though the user may have the opportunity to click to another insurance company's online offering, the user must start a new quote interview on the competitor's site. User provided information may not pass to the insurance company selected by the consumer. As such, the consumer must spend the time to complete another application on the selected insurance company's site. This results in greater attrition during the quoting process and lower click fees to the originating lead aggregator and insurance company.

These inefficiencies are undesirable from a productivity perspective, but also add to marketing costs. Therefore, there is a need for a system that is configured to optimize conversion of actual sales by improving the user experience while reducing total marketing expenses.

### SUMMARY

Provided is a method for furnishing an on-line comparison quote for an insurance product to a user. The method includes receiving user provided information from the user at a computing device on an on-line quote system application for a referring company providing quote data via an on-line quote system web server. The referring company may provide a comparative feature to the on-line quote system application. The user may select the comparative feature. The user provided information may be transferred to an exchange database. The exchange database may apply at least one filter to the user provided information. The user provided information may be provided to an exchange-hosted, business-intelligence engine. The business intelligence engine may analyze the user provided information with at least one credit based insurance scoring model. The business intelligence engine may determine which partner insurance companies may be a ‘match’ for the consumer based upon matching consumer self-admitted data and third party data with each insurance company's proprietary acquisition model and their associated bid for the consumer quote. The business intelligence engine may pass the consumer and associated third party data to the partner insurance company's rating engine. The partner insurance company may process a quote for the user and return rate information back to the exchange database. At least one comparison rate may be displayed to the user via the exchange database on the quote system application via the on-line quote system web server.

In another embodiment, disclosed is a system for furnishing an on-line comparison quote for an insurance product to a user. The system includes a computing device for receiving user provided information from the user. The computing device includes on an on-line quote system application for a referring quote data providing company accessible to a user via an on-line quote system web server. The referring company may provide a comparative feature to the on-line quote system application. The user may select the comparative feature and the user provided information may be transferred to an exchange database. The exchange database may apply at least one filter to the user provided information. The user provided information may be provided to an exchange-hosted, business-intelligence engine. The business intelligence engine may analyze the user provided information with at least one credit based insurance scoring model supporting at least one partner insurance company. The business intelligence engine may determine which partner insurance carriers may be a high quality ‘match’ for the consumer based upon matching consumer self-admitted data and third party data with each insurance company's proprietary acquisition model and their associated bid for the consumer quote. The business intelligence engine may pass the consumer and associated third party data to the partner insurance company's rating engine. The insurance company may process a quote for the consumer and return rate information back to the exchange web server and database. At least one comparison rate may be displayed to the user via the exchange database on the quote system application via the on-line quote system web server.

In another embodiment, disclosed is a method of furnishing an on-line comparison quote for an insurance or financial services product to a user. The method includes receiving user provided information from the user through an on-line quote system application for a referring company via an on-line quote system web server. A comparative feature may be provided to the on-line quote system application. The user provided information may be transferred to an exchange database. At least one filter may be applied to the user provided information via the exchange database. The filtered user provided information may be provided to a business intelligence engine associated with at least one partner insurance company. The user provided information may be analyzed through the business intelligence engine with at least one credit based insurance scoring model from the at least one partner insurance company. At least one comparison rate from the at least one partner insurance company may be generated. The at least one comparison rate may be displayed via the exchange database to the on-line quote system application via the on-line quote system web server.

In one embodiment, the user may be redirected to a portal of the exchange database to view the at least one comparison rate. The at least one filter may be associated with an acquisition model of the at least one partner insurance company such that the filter may be applied to the user provided information to be matched to a bidding structure of the at least one partner insurance company. The referring company may be remunerated through the quote exchange by the at least one partner insurance company for providing the comparative feature to the on-line quote system application. The at least one partner insurance company may provide the comparison rate to reimburse the referring insurance company.

### BRIEF DESCRIPTION OF THE DRAWINGS

The disclosed method and system may be better understood by reference to the following detailed description taken in connection with the following illustrations, wherein:

FIG. 1 is a schematic diagram of embodiments of a system for furnishing an on-line comparison quote for an insurance product to a user in accordance with the present disclosure;

FIG. 2 is a flow chart of embodiments for a system for furnishing an on-line comparison quote for an insurance product to the user;

FIG. 3 is a flow chart of embodiments for a method for furnishing an on-line comparison quote for an insurance product to the user;

FIG. 4 is a flow chart of embodiments for a method for furnishing an on-line comparison quote for an insurance product to the user;

FIG. 5 is an embodiment of an interface for a web site that provides an on-line quote for an insurance product to the user;

FIG. 6 is an embodiment of the interface of FIG. 5 with a comparison feature for furnishing an on-line comparison quote for an insurance product to the user;

FIG. 7 is an embodiment of an interface furnishing on-line comparison quotes for an insurance product to the user;

FIG. 8 is a chart explaining embodiments of the quote exchange database of the present disclosure;

FIG. 9 is a chart explaining embodiments of the quote exchange system of the present disclosure; and

FIG. 10 is an embodiment of an interface furnishing on-line comparison quotes for an insurance product to the user.

### DETAILED DESCRIPTION

Reference will now be made in detail to exemplary embodiments of the present invention, examples of which are illustrated in the accompanying drawings. It is to be understood that other embodiments may be utilized and structural and functional changes may be made without departing from the respective scope of the invention. Moreover, features of the various embodiments may be combined or altered without departing from the scope of the invention. As such, the following description is presented by way of illustration only and should not limit in any way the various alternatives and modifications that may be made to the illustrated embodiments and still be within the spirit and scope of the invention.

Provided is a method and system configured to drive quoting and purchasing behavior of a user to search for and purchase an insurance policy or other financial services product. This disclosure may be particularly directed to automobile insurance policies, however, this disclosure is not limited and may also be adopted for alternative types of insurance products such as life, health, boat, motorcycle, home, and other types of insurance and financial services policies. The system may be a computerized method of allowing customers to make better informed purchases.

Throughout this description, several parties will be referred to when describing the disclosed system and method. These parties will be referred to as the user, the quote exchange database, the referring quote data providing company, and the partnering insurance company or companies. The “user” is the party that is attempting to purchase an insurance policy or other financial product. The user may be any individual or entity such as a corporation, partnership, non-profit organization, school, government entity, etc. The “referring quote data providing company” or “referring company” may be any initiating insurance company or online-company that operates an on-line quote system application configured to issue a quote for an insurance policy. The one or more “partner insurance companies” may be the party that provides comparison quotes to the initial quote from the referring quote data providing company to the user. The “quote exchange database” is a computerize system that acts as a facilitator between the referring quote data providing company, the one or more partnering insurance companies, and the user.

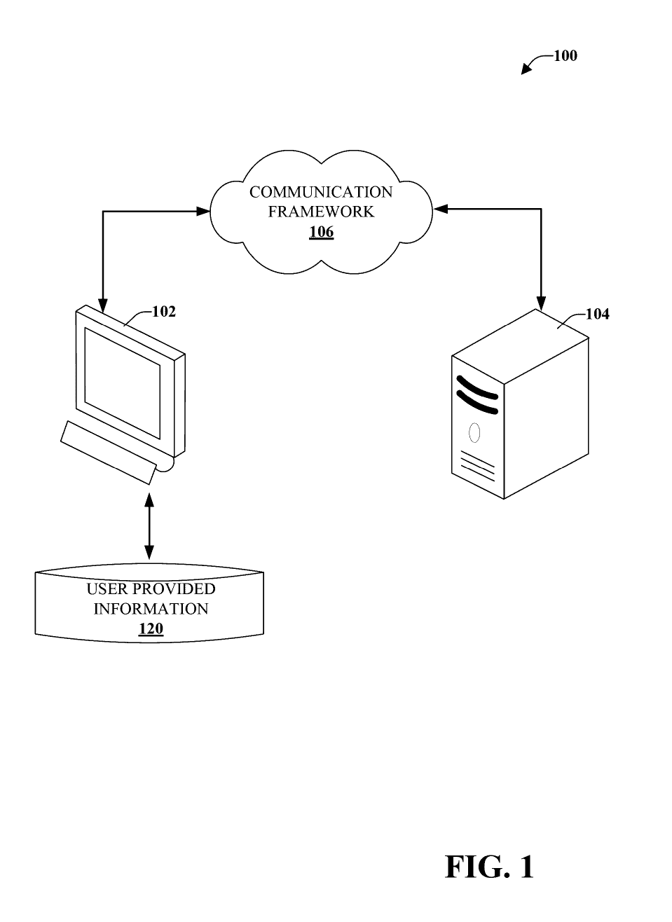

FIG. 1 illustrates the system architecture 100 that may implement the system and method of the present disclosure. In particular, a user display 102 may be in communication with a computer/processor 104 by way of a communication framework 106 such as the internet, network, or cloud as is generally known in the art. The processor 104 and communication framework 106 of the system architecture 100 may also include on on-line web server. The on-line quote system application 210 may be accessible via the on-line quote system web server. The display 102 may be a computer, phone, tablet, television, or other device that is accessible by the user to access a website to fill out an insurance application form to receive a quote and purchase an insurance policy. The user may be prompted to input user provided information 120 at the display 102. The user provided information 120 may include a name, date, age, vehicle type, address, insurance limits desired, or other data required to generate an insurance quote.

It has been found that users in search of an insurance product prefer to be provided with various competitive rates from a plurality insurance companies before making a decision to purchase a policy. It is the intent of this method and system to capture more sales of policies to customers while reducing the overall cost of marketing. In particular, this system and method may reduce the cost for buying consumer leads from lead aggregators by recouping marketing dollars on quoted customers that do not purchase from the company that initially purchased the lead.

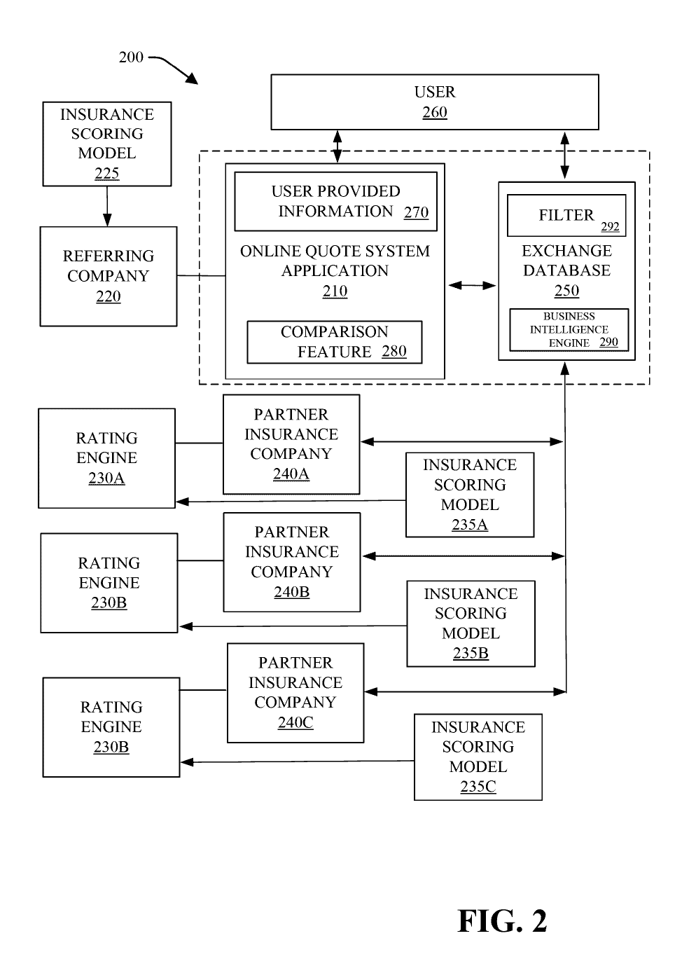

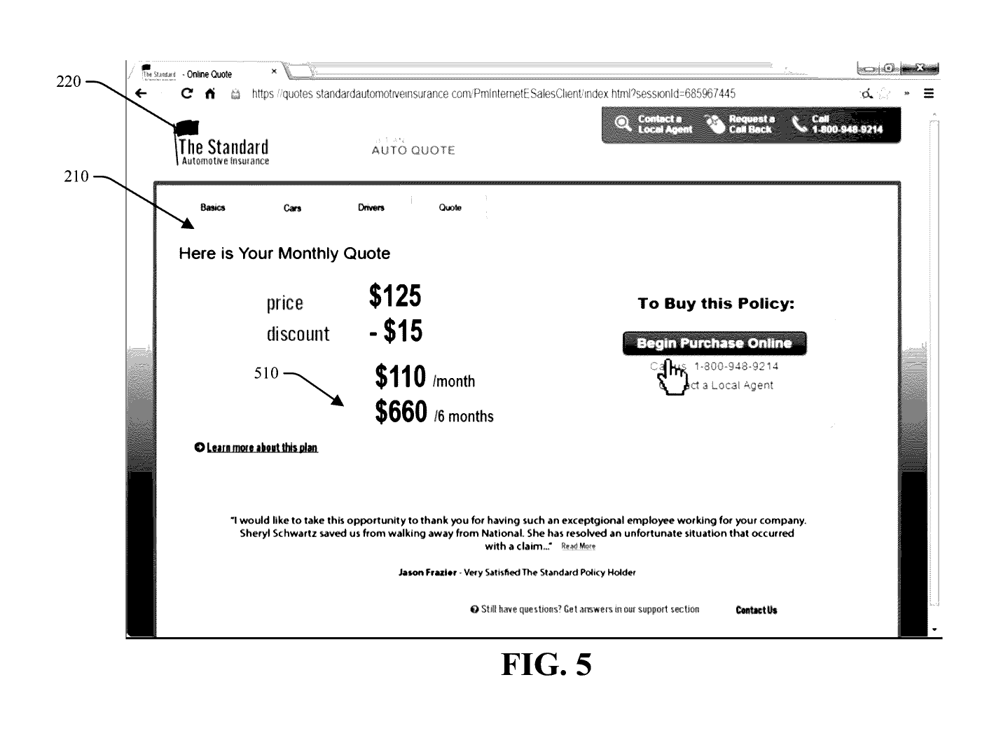

In one embodiment, the user 260 engages in on-line shopping for an insurance product. As illustrated by FIG. 2, the user 260 may be directed to the website of a referring company 220 (See also FIG. 5). This website may include an online quote system application 210 in which the user 260 may be prompted to input user provided information 270. The referring company 220 may then utilize this user provide information 270 in addition to third party information such as insurance scoring models 225 to generate a quote 510 for the insurance product. The quote 510 may be displayed on the online quote system application 210 for the user 260 to review. The referring company 220 may be an insurance company or another entity organized to provide quote data to the user.

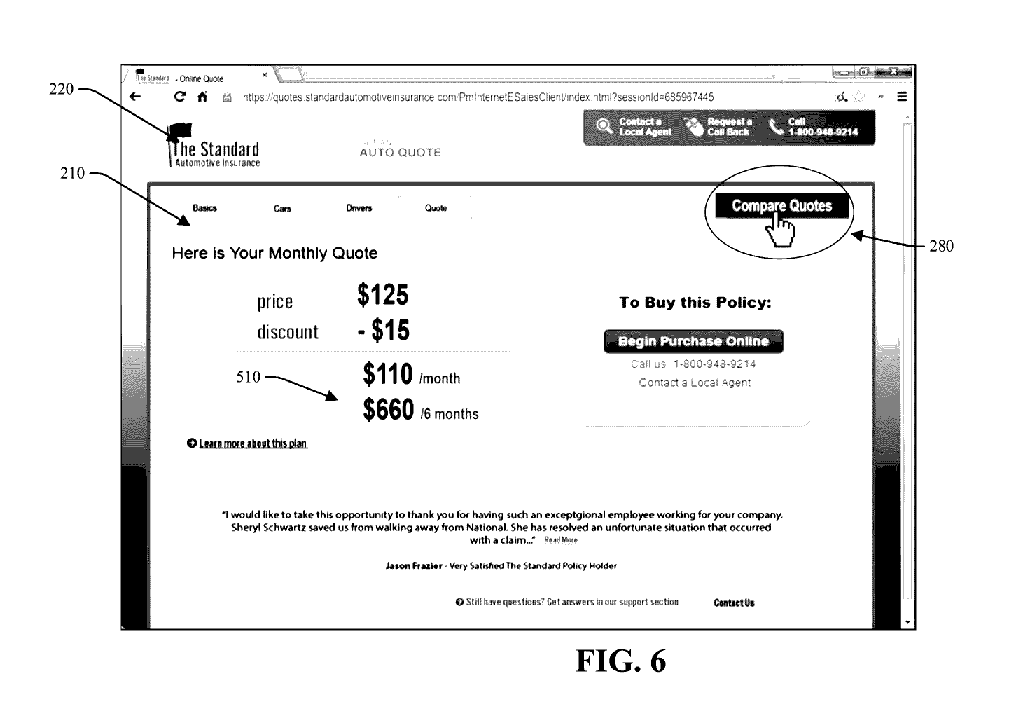

The referring company 220 may offer the initial quote 510 for the insurance policy to the user 260 and also provide a comparative feature 280 such as button, link, or tab within the website or online quote application 230 to allow the user 260 to select and have access to comparative rates from at least one of a plurality of partner insurance companies 240A, 240B, 240C (See also FIG. 6). Although FIG. 2 illustrates three (3) partner insurance companies, this disclosure contemplates that any amount may participate within this system and method. The comparative features 280 may be a link, may be a button on the website, or a tab that is displayed on the insurance companies interface. This link may be displayed at any time as the user 260 inputs the user provided information 270. In one embodiment, the comparative feature 280 may be hidden from the application wherein the comparative feature 280 may become visible after the user inputs the user provided information 270.

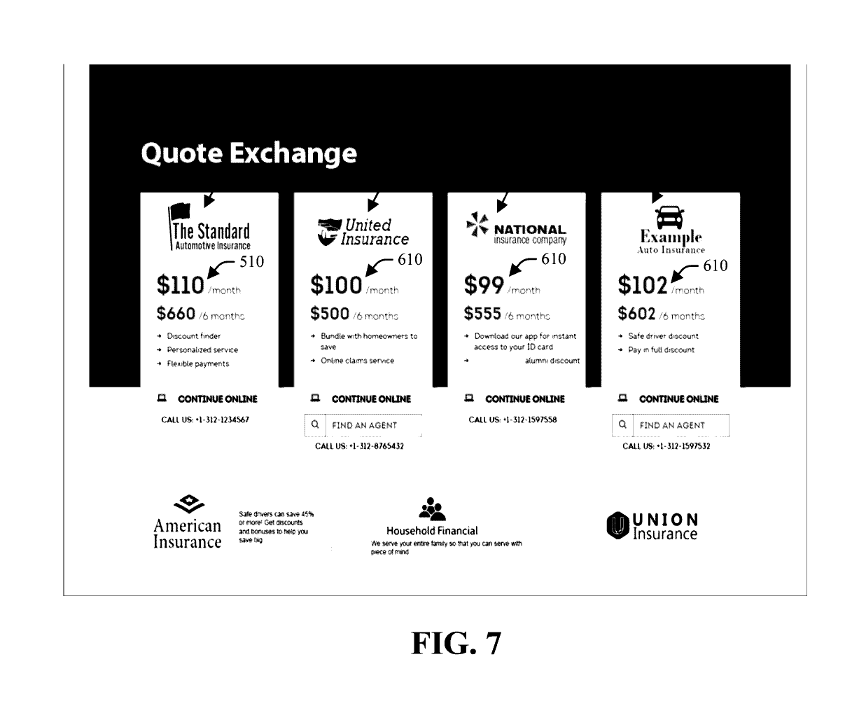

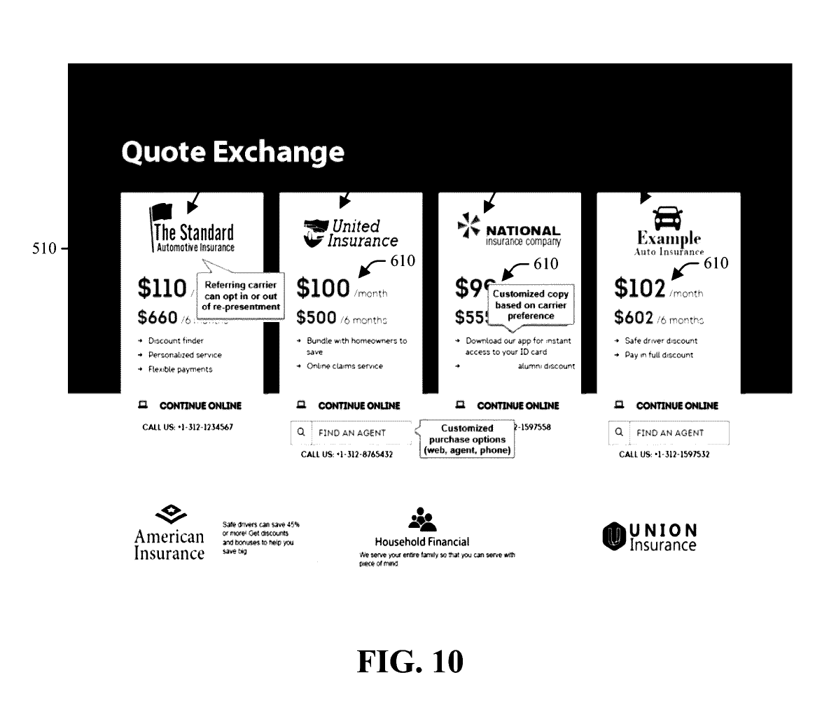

Once a consumer selects the option to compare rates by selecting the comparative feature 280, the exchange database 250 provides each participating partner insurance company with the ability to identify users that align to their preferred business risk. The online quote system application 210 transfers the user provided information 270 to the exchange database 250. This can be done by transferring data over the communication framework 106 such as a network. The data may be in the form of XML, JSON, among others, and the type of markup langue of the data transfer is not limited. The exchange database 250 may apply additional third party data such as the insurance scoring model 225 to analyze and rank the user 260 as a potential customer. The exchange application 250 may optionally score and filter the information through a variety of criteria. The user provided information 270 may be filtered to include desired customers that qualify under a particular category, for example, gender, age, demographics, or a range of various categories such as men in the age of 35-55, women aged 40-60, etc. These filtered/qualified user information may be sorted and ranked as desired by the partner insurance companies 240. The exchange application 250 may provide the partner insurance companies 240A, 240B, 240C the ability to filter or qualify potential customer information such as each respective companies' consumer acquisition models, including insurance scoring models, credit score and credit score attributes, court records regarding the user's driving history, potential fraud indicators, or other information before having to decide to purchase a customer lead by submitting a bid to the exchange database 250. The partner insurance company may have a full view of the user's attributes prior to deciding whether to bid and spend marketing dollars to present a comparison quote 610 to the user 260. At least one comparison quote 610, in addition to the initial quote 510 from the referring company 220 may be displayed on the quote exchange system as illustrated by FIGS. 7 and 10.

Once the determination is made that the user and the user profile constitutes a desirable lead, the partner insurance companies may offer the bid to the exchange database 250. The exchange database may rank the bids offered by the partner insurance companies to present a comparative quote to the user relative to each partner insurance company's unique acquisition model (including insurance scoring model, etc). The partner insurance companies that placed acceptable bids may be charged the bid amount in return for presenting the partner insurance company's comparison quote to the user.

In this regard, the partner insurance company(ies) 240A, 240B, 240C may be provided with the user provided information 270. The partner insurance company may analyze the user provided information 270 in addition to its proprietary insurance scoring models 235A, 235B, 235C and other third-party data via a rating engine 230A, 230B, 230C to assess the user's fit or match within the insurance company's “acquisition model.” The insurance company acquisition model may include information related to the user's insurance history, credit score and credit score attributes, court records regarding the user's driving history, potential fraud indicators, or other information. Note that an “insurance score” may be predicated on consumer credit attributes while an “acquisition model” may be predicated on a full range of consumer attributes including insurance score, demographics, geography, target market attributes, gender, age, etc. For example, territory is not an insurance score attribute, but it can be an acquisition model attribute.

The system 200 offers the ability to monetize the consumer lead (user provided information) in the event that the referring company 220 does not convert the user 260 into a policyholder, and in some cases where the referring company 220 ultimately does convert the user 260 into a policyholder. Further, the user 260 seeking to view quotes and/or purchase an insurance policy from the referring company 220 may be able to explore rates/policies from other insurance companies without having to reenter their personal information on other websites.

Once the user 260 selects the desired shopping method, the winning insurance company bidders may be determined. The exchange database 250 may transfer user provided information 270 and third party data to the selected insurance company, and the selected insurance company may provide the exchange database with a bindable rate offering (“bindable rate” is a final, purchasable rate at which a consumer can purchase an insurance policy pending verification of user provided information and 3^{rd} party data providers).

In this instance, the partner insurance companies that win the bids provide rates to targeted consumers with a high probability of conversion. The targeted consumers are particularly filtered per the desired criteria. For the user, the probability of a successful transaction is elevated as the rates offered are provided based upon the fact that the bidding insurance company is targeting to that consumer specifically.

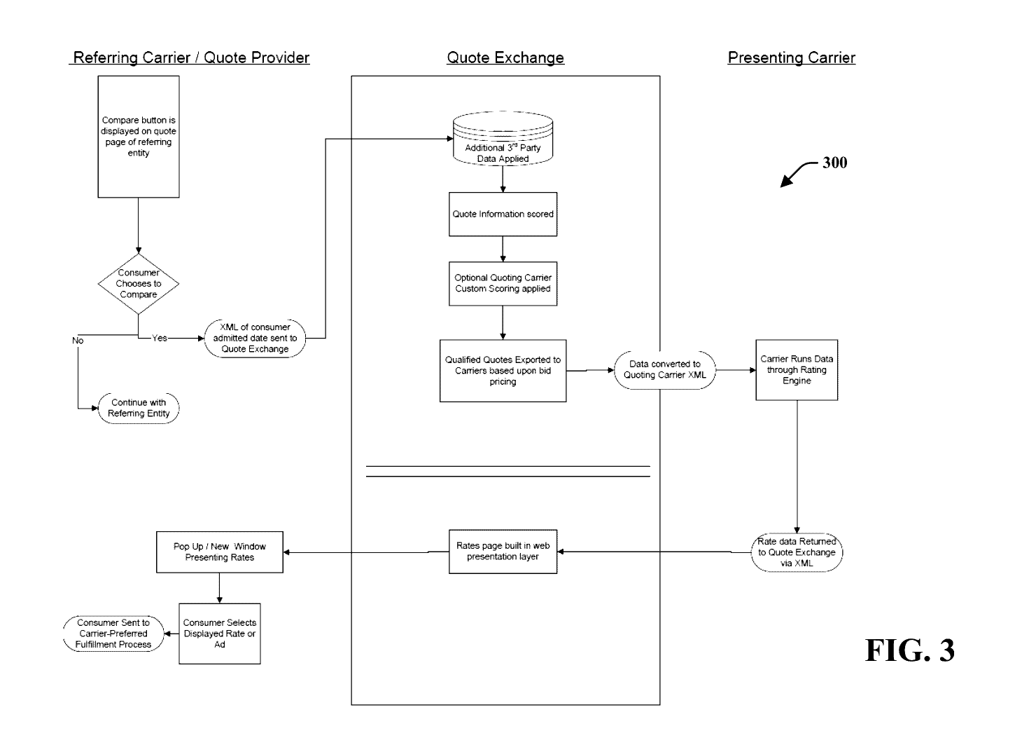

FIG. 3 illustrates and describes the function of system 300 which is comparable to the system 200 of FIG. 2. In this embodiment, the referring carrier/quote provider displays a comparative features or button on its webpage (see FIG. 6). The consumer chooses the compare feature after entering consumer provided information. The consumer admitted data is sent to the quote exchange system. Additional third party data is applied to the consumer admitted data to score a particular quote. This score may be optionally filtered based on various criteria to determine a qualified score associated with a qualified consumer. The qualified consumer data is provided to at least one presenting carrier in exchange for payment from the presenting carrier to the referring carrier/quote provider. The presenting carrier analyzes the qualified consumer data through its proprietary rating engine to identify a bindable quote or rate. The bindable rate is transferred to the quote exchange system to be presented onto the presentation layer of the web page (see FIGS. 7 and 10). The quote exchange system may provide a pop up window at the user's display to present the original bindable rate 510 as well as bindable rates 610 from other presenting carriers, if available. The consumer may then select a displayed rate or other link, such as an advertisement, provided. The consumer may then be routed to the selected presenting carrier for the fulfillment process to finalize the purchase of the policy.

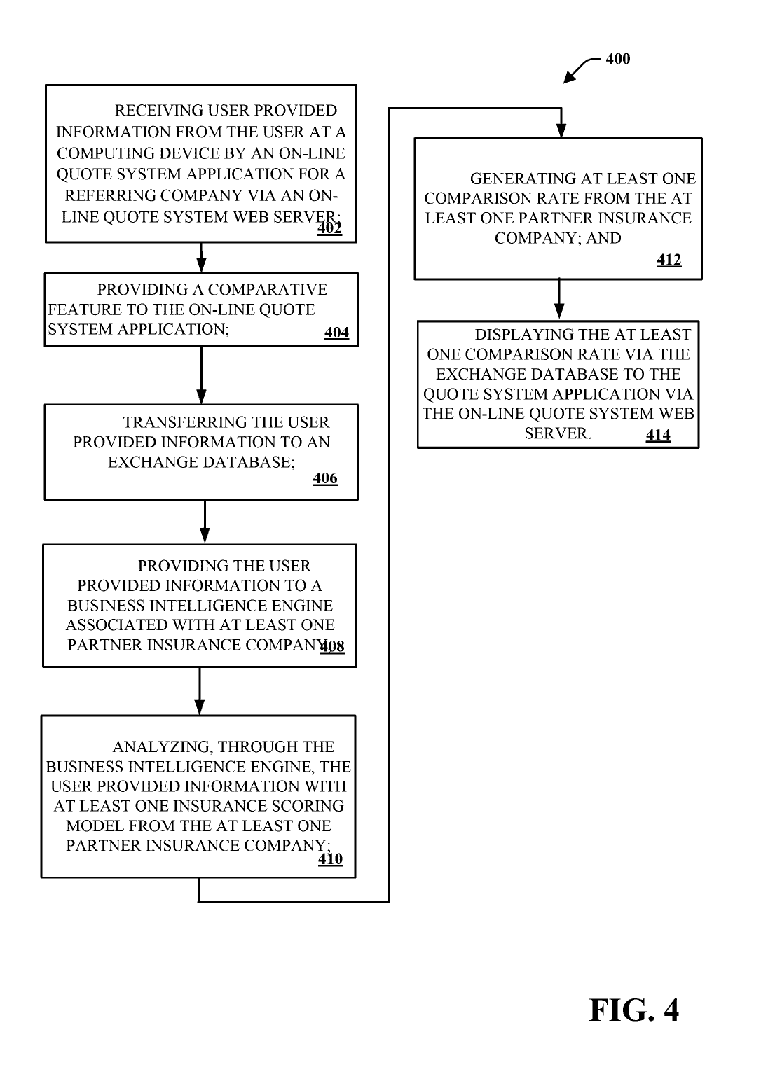

FIG. 4 illustrates a schematic diagram of a method 400 of the present disclosure. Provided is the method 400 of furnishing an on-line comparison quote for an insurance product to a user. In step 402, the computing device receives user provided information from the user, the computing device displaying an on-line quote system application for the referring quote data providing company via an on-line quote system web server. In step 404, a comparative feature is provided to the on-line quote system application. In step 406, the user provided information may be transferred to an exchange database. In step 408, the user provided information may be provided to a business-intelligence engine associated with at least one partner insurance company. In step 410, the business-intelligence engine may analyze the user provided information with at least one insurance scoring model from the at least one partner insurance company. In step 412, the business-intelligence engine may identify at least one comparison rate for the insurance policy from the at least one partner insurance company. In step 414, the at least one comparison rate may be displayed via the exchange database to the on-line quote system application via the on-line quote system web server. The at least one comparison rate may be responsive to the user provided information and the at least one insurance scoring model of the at least one partner insurance company.

The quote exchange system and method of the present disclosure allows quoting companies to target consumers using consumer self-admitted data and a broad variety of third party data including, but not limited to, credit scoring, insurance scoring, consumer driving history, vehicle history, fraud detection (and other data) before comparison companies (partner insurance companies) spend marketing dollars. The quote exchange system and method allows companies to screen the consumer pool before deciding to spend marketing dollars. In many instances the consumer utilizing the quote exchange system and method will begin this process through a service provider's consumer interview, and will engage the quote exchange on the original service provider's rate/services offering page.

FIG. 5 is an embodiment of an interface for a website that provides an on-line quote 510 for an insurance product to the user. The interface displays the online quote system application 210. FIG. 6 is an embodiment of the interface of FIG. 5 with the comparison feature 280 for furnishing an on-line comparison quote 510 for an insurance product to the user.

FIG. 7 is an embodiment of an interface furnishing a plurality of on-line comparison quotes 510, 610 for an insurance product to the user. This interface may be a pop up window that includes quotes 610 from at least one partner insurance company 240A, 240B, 240C as well as the original quote from the referring company 220.

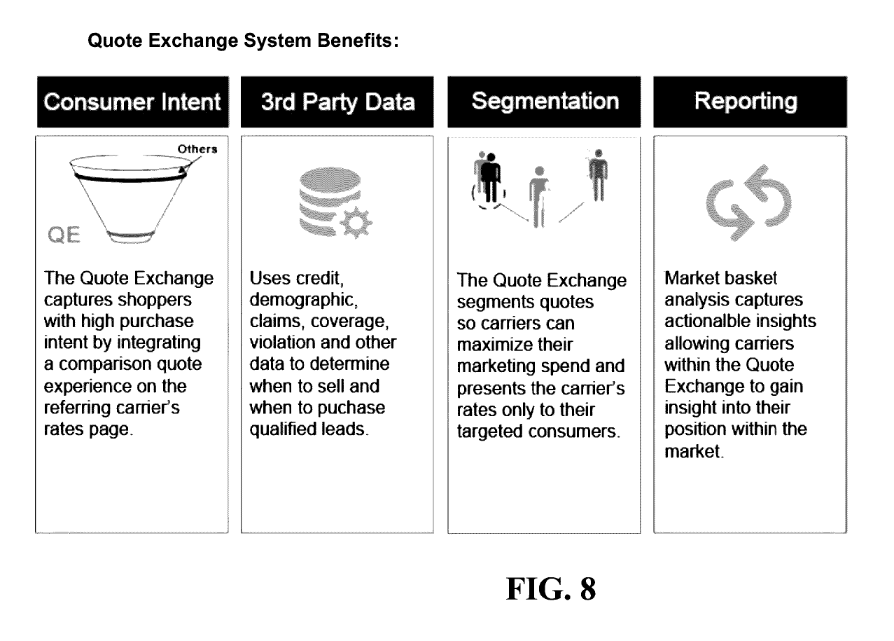

FIG. 8 is a chart explaining beneficial embodiments of the quote exchange database of the present disclosure. The quote exchange may capture shoppers with high purchase intent by integrating a comparison quote feature on the referring carrier's rate page. The quote exchange system may use third party data such as as credit, demographic, claims, coverage, violations, and other data to determine when to sell and when a partner insurance company may decide to bid on or purchase qualified leads. The quote exchange system may segment or filter quotes so that the partner insurance company can maximize their marketing spend and present their rates to targeted customers identified with improved accuracy. The quote exchange system may include a reporting feature to analyze market insights to allow partner carriers to review their position in the market.

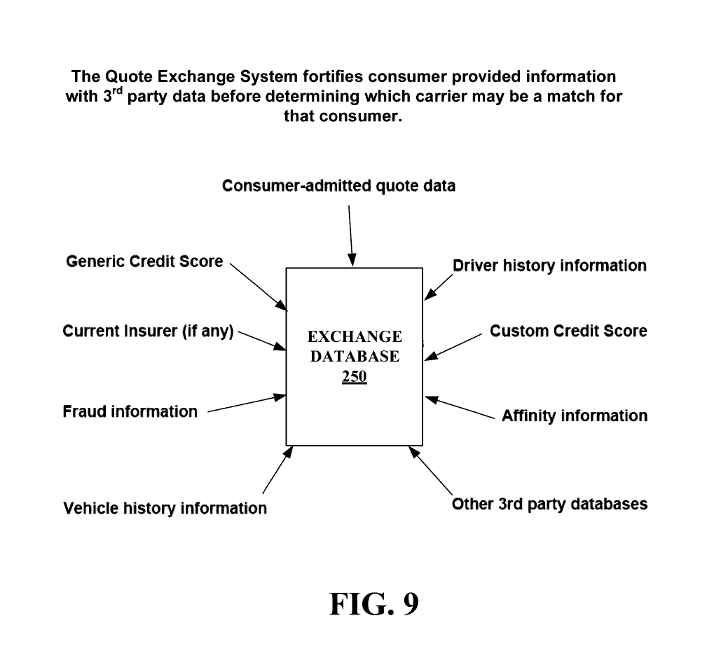

FIG. 9 is a chart explaining embodiments of a feature of quote exchange system of the present disclosure. The exchange database 250 may filter the consumer-admitted quote data or the consumer provided data with various third party information. This third party information may include a generic credit score, the user's current insurer, fraud information, vehicle history information, driver history information, custom credit score, affinity information, and other third party databases. This feature may allow the quote exchange system to filter the consumer provided information to allow a partner insurance company or carrier to determine if they may be a match or fit for that consumer or that partner insurance company.

FIG. 10 is an embodiment of an interface furnishing a plurality of on-line comparison quotes 510, 610 for an insurance product from at least one partner insurance company 240A, 240B, 240C as well as the referring company 220 to the user. The interface may be customized in various ways. Particularly, the referring company may opt in or out of representation in the comparison interface. Each quote 610 may include customized purchase options for the user such as by web, agent, or by phone. Also, each partner insurance company may be able to customize its display in a particular manner as presented to the user. This customization may allow for advertisements or other links to access features such as ID cards, bundled service options, or other discounts.

Although the embodiments of the present invention have been illustrated in the accompanying drawings and described in the foregoing detailed description, it is to be understood that the present invention is not to be limited to just the embodiments disclosed, but that the invention described herein is capable of numerous rearrangements, modifications and substitutions without departing from the scope of the claims hereafter. The claims as follows are intended to include all modifications and alterations insofar as they come within the scope of the claims or the equivalent thereof.

Having thus described the invention, the following is claimed:

1. A method of furnishing an on-line comparison quote for an insurance or financial services product to a user, the method comprises:
receiving user provided information from the user at a computing device by an on-line quote system application for a referring company via an on-line quote system web server;
providing a comparative feature to the on-line quote system application;
transferring the user provided information to an exchange database;
providing the user provided information to a business intelligence engine associated with at least one partner insurance company;
analyzing, through the business intelligence engine, the user provided information with at least one credit based insurance scoring model from the at least one partner insurance company;
generating at least one comparison rate from the at least one partner insurance company; and
displaying the at least one comparison rate via the exchange database to the on-line quote system application via the on-line quote system web server, the at least one comparison rate being responsive to the user provided information and to the credit based insurance scoring model from the at least one insurance company.

2. The method of claim 1, further comprising applying at least one filter to the user provided information via the exchange database before generating at least one comparison rate.

3. The method of claim 1, wherein displaying the at least one comparison rate further comprises redirecting the user to a portal of the exchange database.

4. The method of claim 1, wherein the user may select and purchase an insurance product or financial services product associated with the at least one comparison rate displayed by the exchange database.

5. The method of claim 1, wherein the referring company may be remunerated through the quote exchange by the at least one partner insurance company for providing the comparative feature to the on-line quote system application.

6. The method of claim 5, wherein the at least one partner insurance company provides the comparison rate to reimburse the referring insurance company.

7. A system for furnishing an on-line quote for an insurance product to a user, the system comprises:
an on-line quote system application for a referring company accessible to a user via an on-line quote system web server, the on-line quote system application to receive user provided information from the user;
a comparative feature provided on the on-line quote system application wherein the user may select the comparative feature to review at least one comparative rate;
wherein the user provided information is transferred to an exchange database;
wherein at least one filter is applied to the user provided information;
at least one rating engine of at least one partner insurance company receives the user provided information to analyze the user provided information with at least one insurance scoring model to generate the at least one comparative rate for an insurance product;
wherein the at least one comparative rate is displayed to the user on the quote system application via the on-line quote system web server.

8. The system of claim 7 wherein the at least one comparison rate may be responsive to the user provided information and the at least one insurance company acquisition model, including the credit based insurance scoring model of at least one partner insurance company.

9. The system of claim 7 wherein the at least one comparison rate may be responsive to the user provided information and the at least one credit based insurance scoring model of the at least one partner insurance company.

10. The system of claim 7 wherein the at least one filter is associated with an acquisition model of the at least one partner insurance company such that the filter is applied to the user provided information to be matched to a bidding structure of the at least one partner insurance company.

11. The system of claim 7 wherein the at least one comparative rate is displayed to the user via the exchange database on the quote system application via the on-line quote system web server on a pop up window.

12. A system for furnishing a real-time on-line quote for an insurance product for a user, comprising:
a computing device for receiving user provided information from the user, the computing device includes on an on-line quote system application for a referring company accessible to a user via an on-line quote system web server;
a comparative feature is provided to the on-line quote system application wherein the user may select the comparative feature to review at least one comparative rate;
wherein user provided information is transferred to an exchange database;
wherein at least one filter is applied to the user provided information;
at least one rating engine of at least one partner insurance company receives the user provided information to analyze the user provided information with at least one insurance scoring model to generate at least one comparison rate for an insurance product;
wherein the at least one comparison rate is displayed to the user via the online quote system application via the on-line quote system web server.

13. The system of claim 12 wherein the at least one comparison rate may be responsive to the user provided information and the at least one insurance company acquisition model, including the credit based insurance scoring model of at least one partner insurance company.

14. The system of claim 12 wherein the at least one comparison rate may be responsive to the user provided information and the at least one credit based insurance scoring model of the at least one partner insurance company.

15. The system of claim 12 wherein the at least one filter is associated with an acquisition model of the at least one partner insurance company such that the filter is applied to the user provided information to be matched to a bidding structure of the at least one partner insurance company.

16. A method of furnishing an on-line comparison quote for an insurance or financial services product to a user, comprising:
receiving user provided information from the user through an on-line quote system application for a referring company via an on-line quote system web server;
providing a comparative feature to the on-line quote system application;
transferring the user provided information to an exchange database;
applying at least one filter to the user provided information via the exchange database;
providing the filtered user provided information to a business intelligence engine associated with at least one partner insurance company;
analyzing, through the business intelligence engine, the user provided information with at least one credit based insurance scoring model from the at least one partner insurance company;
generating at least one comparison rate from the at least one partner insurance company; and
displaying the at least one comparison rate via the exchange database to the on-line quote system application via the on-line quote system web server.

17. The method of claim 16, wherein displaying the at least one comparison rate further comprises redirecting the user to a portal of the exchange database.

18. The method of claim 16 wherein the at least one filter is associated with an acquisition model of the at least one partner insurance company such that the filter is applied to the user provided information to be matched to a bidding structure of the at least one partner insurance company.

19. The method of claim 18, wherein the referring company may be remunerated through the quote exchange by the at least one partner insurance company for providing the comparative feature to the on-line quote system application.

20. The method of claim 19, wherein the at least one partner insurance company provides the comparison rate to reimburse the referring insurance company.
